(19) United States
(12) Patent Application Publication
(10) Pub. No.: US 2025/0139954 A1
(43) Pub. Date: May 1, 2025

(54) METHOD AND APPARATUS FOR TRAINING BACKBONE NETWORK, IMAGE PROCESSING METHOD AND APPARATUS, AND DEVICE

(71) Applicant: Lemon Inc., Grand Cayman (KY)

(72) Inventors: Xueqing Deng, Los Angeles, CA (US); Qi Fan, Beijing (CN); Peng Wang, Los Angeles, CA (US); Linjie Yang, Los Angeles, CA (US); Xiaojie Jin, Los Angeles, CA (US)

(21) Appl. No.: 18/926,902

(22) Filed: Oct. 25, 2024

(30) Foreign Application Priority Data
Oct. 26, 2023 (CN) 202311405985.1

(51) Int. Cl. G06V 10/778; G06V 10/77; G06V 10/82

(52) U.S. Cl. CPC G06V 10/778; G06V 10/7715; G06V 10/82

(57) ABSTRACT

The present application discloses a method and an apparatus for training a backbone network, an image processing method and apparatus, and a device. A weight selection cycle is set, where the weight selection cycle may include at least one backbone network training cycle. The backbone network is trained with sample data in the current weight selection cycle, and a cumulative weight adjustment amount for each weight in the backbone network in the current weight selection cycle is recorded. A target weight for which the cumulative weight adjustment amount meets a preset condition is selected from the backbone network based on the cumulative weight adjustment amount for each weight, and only the target weight in the backbone network is adjusted in a next weight selection cycle, to complete training of the backbone network in the next weight selection cycle based on the adjusted target weight.

### CROSS-REFERENCE TO RELATED APPLICATION(S)

This application claims priority to Chinese Application No. 202311405985.1 filed Oct. 26, 2023, the disclosure of which is incorporated herein by reference in its entirety.

### FIELD

The present application relates to the field of computer technologies, and specifically to a method and an apparatus for training a backbone network, an image processing method and apparatus, and a device.

### BACKGROUND

In the field of computer vision, a backbone network is mainly used for image feature extraction in the field, to implement dense prediction tasks, such as semantic segmentation, depth estimation, edge detection, and key point detection. At present, the backbone network may be pre-trained based on large-scale datasets. However, the backbone network is trained on an electronic device with a relatively low efficiency, which increases the number of resources used by the electronic device.

### SUMMARY

In view of this, the present application provides a method and an apparatus for training a backbone network, an image processing method and apparatus, and a device, which can improve the efficiency of training the backbone network on an electronic device, thereby reducing the number of resources used by the electronic device.

To solve the above problem, the technical solution provided in the present application is as follows.

According to a first aspect, the present application provides a method for training a backbone network, where in the backbone network, adjacent neural network layers are associated with each other and have associated weights. The method includes:
setting a weight selection cycle, where the weight selection cycle includes at least one backbone network training cycle;
training the backbone network with sample data in the current weight selection cycle, and recording a cumulative weight adjustment amount for each weight in the backbone network in the current weight selection cycle, where the sample data includes sample images in the field of computer vision;
determining, as a target weight in the backbone network, a weight for which the cumulative weight adjustment amount meets a preset condition; and
adjusting the target weight in the backbone network, to complete training of the backbone network in a next weight selection cycle based on the adjusted target weight.

According to a second aspect, the present application provides an image processing method. The method includes:
generating an image processing model for use in the field of computer vision by using a backbone network generated by training through the method according to the first aspect; and
inputting a computer vision image to be processed into the image processing model, to obtain an image processing result.

According to a third aspect, the present application provides an apparatus for training a backbone network, where in the backbone network, adjacent neural network layers are associated with each other and have associated weights. The apparatus includes:
a setting unit configured to set a weight selection cycle, where the weight selection cycle includes at least one backbone network training cycle;
a recording unit configured to train the backbone network with sample data in the current weight selection cycle, and record a cumulative weight adjustment amount for each weight in the backbone network in the current weight selection cycle, where the sample data includes sample images in the field of computer vision;
a determination unit configured to determine, as a target weight in the backbone network, a weight for which the cumulative weight adjustment amount meets a preset condition; and
an adjustment unit configured to adjust the target weight in the backbone network, to complete training of the backbone network in a next weight selection cycle based on the adjusted target weight.

According to a fourth aspect, the present application provides an image processing apparatus. The apparatus includes:
a generation unit configured to generate an image processing model for use in the field of computer vision by using a backbone network generated by training through the method according to the first aspect; and
a processing unit configured to input a computer vision image to be processed into the image processing model, to obtain an image processing result.

According to a fifth aspect, the present application provides an electronic device. The electronic device includes:
one or more processors; and
a storage apparatus having one or more programs stored thereon, where
the one or more programs, when executed by the one or more processors, cause the one or more processors to implement the method according to any one of the aspects.

According to a sixth aspect, the present application provides a computer-readable storage medium having a computer program stored thereon, where when the computer program is executed by a processor, the method according to any one of the aspects is implemented.

It can be learned that the present application has the following beneficial effects.

The present application provides a method and an apparatus for training a backbone network, an image processing method and apparatus, and a device. In the backbone network, adjacent neural network layers are associated with each other and have associated weights. During training of the backbone network, the weights in the backbone network need to be adjusted to improve the performance of the backbone network. To improve the efficiency of training the backbone network on the electronic device, in this training method, a weight selection cycle is first set, where the weight selection cycle may include at least one backbone network training cycle. With the current weight selection cycle as an example, the backbone network is trained with sample data (i.e., sample images in the field of computer vision) in the current weight selection cycle, that is, the backbone network is trained based on the sample data in each backbone network training cycle within the current weight selection cycle. Thereafter, a cumulative weight adjustment amount for each weight in the backbone network in the current weight selection cycle is recorded. A greater cumulative weight adjustment amount indicates a greater change in the weight, which may show the importance of the weight during the training of the backbone network. On this basis, it is determined whether the cumulative weight adjustment amount for each weight meets a preset condition, and a weight that meets the preset condition is selected and determined as a target weight in the backbone network. Then, only the target weight in the backbone network needs to be adjusted in a next weight selection cycle. Training of the backbone network in the next weight selection cycle is completed based on the adjusted target weight.

It can be learned that as compared to the adjustment to all the weights in the backbone network in each backbone network training cycle, the present application makes it possible to select, from the backbone network and based on the cumulative weight adjustment amount for each weight in the current weight selection cycle, the target weight for which the cumulative weight adjustment amount meets the preset condition, and adjust only the target weight in the next weight selection cycle. In this way, only a small number of weights in the backbone network need to be adjusted, while other weights remain unchanged, so that the number of resources used by the electronic device in training the backbone network is reduced, and the efficiency of training the backbone network on the electronic device is improved.

### BRIEF DESCRIPTION OF THE DRAWINGS

FIG. 1 is a schematic diagram of a framework of an exemplary application scenario according to an embodiment of the present application;

FIG. 2 is a flowchart of a method for training a backbone network according to an embodiment of the present application;

FIG. 3 are schematic diagrams of structures of backbone networks according to an embodiment of the present application;

FIG. 4 is a schematic diagram of backbone network weight selection and backbone network training according to an embodiment of the present application;

FIG. 5 is a schematic diagram of a structure of a feature adapter according to an embodiment of the present application;

FIG. 6 is a flowchart of an image processing method according to an embodiment of the present application;

FIG. 7 is a schematic diagram of a structure of an apparatus for training a backbone network according to an embodiment of the present application;

FIG. 8 is a schematic diagram of a structure of an image processing apparatus according to an embodiment of the present application; and

FIG. 9 is a schematic diagram of a basic structure of an electronic device according to an embodiment of the present application.

### DETAILED DESCRIPTION OF EMBODIMENTS

In order to make the objectives, features and advantages of the present application more clearly understood, the embodiments of the present application will be further described in detail below with reference to the accompanying drawings and specific implementations.

To facilitate understanding and explanation of the technical solutions provided in the embodiments of the present application, the background art of the present application is first described below.

In the field of computer vision, backbone networks may be used to form a large model, for example, a large vision Transformer model. The large vision Transformer model is used to implement dense prediction tasks, which are a class of important tasks in the field of computer vision, such as semantic segmentation, depth estimation, edge detection, and key point detection.

In the large visual Transformer model, the backbone network may be used to complete feature extraction, for example, image feature extraction. In the dense prediction tasks, an image may be a medical image, a vehicle condition image, a facial image, an image in an autonomous driving scenario, and other images in various application scenarios, which is not limited herein.

At present, the backbone network may be pre-trained based on large-scale datasets. However, the backbone network is trained on an electronic device with a relatively low efficiency, which increases the number of resources used by the electronic device.

On this basis, the embodiments of the present application provide a method and an apparatus for training a backbone network, an image processing method and apparatus, and a device. In the backbone network, adjacent neural network layers are associated with each other and have associated weights. In the training method, a weight selection cycle is first set, where the weight selection cycle may include at least one backbone network training cycle. With the current weight selection cycle as an example, the backbone network is trained with sample data (i.e., sample images in the field of computer vision) in the current weight selection cycle, that is, the backbone network is trained based on the sample data in each backbone network training cycle within the current weight selection cycle. Thereafter, a cumulative weight adjustment amount for each weight in the backbone network in the current weight selection cycle is recorded. A greater cumulative weight adjustment amount indicates a greater change in the weight, which may show the importance of the weight during the training of the backbone network. On this basis, a weight that meets a preset condition is selected and determined as a target weight in the backbone network. Then, only the target weight in the backbone network needs to be adjusted in a next weight selection cycle. Training of the backbone network in the next weight selection cycle is completed based on the adjusted target weight.

It can be learned that as compared to the adjustment to all the weights in the backbone network in each backbone network training cycle, the present application makes it possible to select, from the backbone network and based on the cumulative weight adjustment amount for each weight in the current weight selection cycle, the target weight for which the cumulative weight adjustment amount meets the preset condition, and adjust only the target weight in the next weight selection cycle. In this way, only a small number of weights in the backbone network need to be adjusted, while other weights remain unchanged, so that the number of resources used by the electronic device in training the backbone network is reduced, and the efficiency of training the backbone network on the electronic device is improved.

It can be understood that the defects that exist in the above solution are the product of practice and study by the applicants. Therefore, the process of discovering the above problem, and the solutions to the above problem that are proposed in the embodiments of the present application hereinafter should all be contributions made by the applicants to the embodiments of the present application in the course of the present application.

The method for training a backbone network according to the embodiments of the present application may be applied to computer vision tasks such as semantic segmentation, depth estimation, edge detection, key point detection, image classification, and object detection, and is used for training a backbone network in a machine learning model, such as a semantic segmentation model, a depth estimation model, an edge detection model, a key point detection model, an image classification model, and an object detection model, such that a trained backbone network can be deployed in a lightweight electronic device. The lightweight electronic device includes a portable device with limited storage space and computing power resources, for example, an end-side device such as a mobile terminal and an embedded terminal. The lightweight electronic device may also include an edge computing device in an edge environment. The edge environment indicates a cluster of edge computing devices that are geographically close to a terminal (i.e., an end-side device) and are used to provide computing, storage, and communication resources. The cluster of edge computing devices includes one or more edge computing devices, which may be servers, computing boxes, etc.

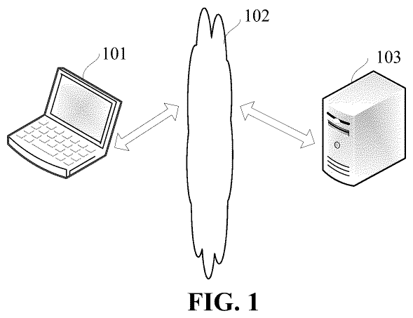

To facilitate understanding of the method for training a backbone network according to the embodiments of the present application, the description is made below in conjunction with a scenario example shown in FIG. 1. Referring to FIG. 1, it is a schematic diagram of a framework of an exemplary application scenario according to an embodiment of the present application.

The framework consists of a terminal device 101, a network 102, and a server 103. The terminal device 101 may be a smartphone, a tablet computer, a laptop computer, a desktop computer, and other terminal devices, which is not limited herein. The network 102 is used to provide a communication link between the terminal device 101 and the server 103. The communication link may be a wired communication link, a wireless communication link, etc., which is not limited herein. The server 103 may be a stand-alone physical server, or a server cluster or a distributed system consisting of a plurality of physical servers, or a cloud server providing basic cloud computing services, such as a cloud service, a cloud database, cloud computing, a cloud function, cloud storage, a network service, and cloud communication, which is not limited herein.

In a practical application, the terminal device 101 may send a training request for a backbone network to the server 103 through the network 102 in response to a request operation of a user, so that the server 103 completes training and deployment of the backbone network by performing the method for training a backbone network according to the embodiments of the present application.

Those skilled in the art can understand that the schematic diagram of the framework shown in FIG. 1 is merely one example in which the implementations of the present application may be implemented. The scope of application of the implementations of the present application is not limited in any way by the framework.

To facilitate understanding of the present application, the method for training a backbone network according to the embodiments of the present application is described below with reference to the accompanying drawings.

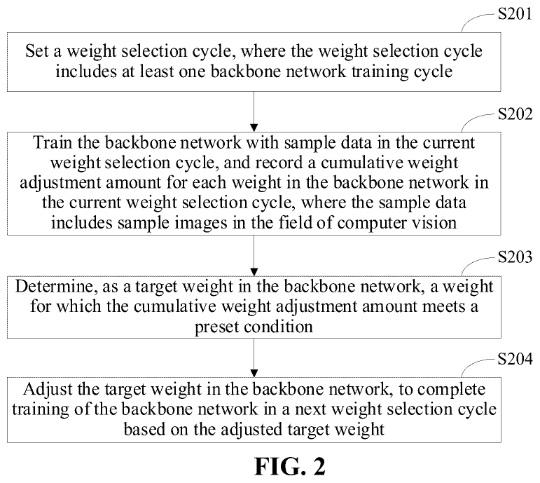

Referring to FIG. 2, it is a flowchart of a method for training a backbone network according to an embodiment of the present application. The method may be applied to an electronic device in which a backbone network is deployed. As shown in FIG. 2, the method may include S201 to S204.

S201: Set a weight selection cycle. The weight selection cycle includes at least one backbone network training cycle.

Generally, the backbone network may be trained after the backbone network is constructed and hyperparameters in the backbone network are determined. The hyperparameters in the backbone network are not limited herein, which may be set according to actual situations. The backbone network is composed of neural networks. In the backbone network, adjacent neural network layers are associated with each other and have a set of associated weights. Specifically, a neuron in each neural network layer has a weight associated with a neuron in an adjacent neural network layer. For example, the first neuron in an i^{th} neural network layer has a weight associated with the first neuron in an (i+1)^{th} neural network layer. This is analogous for the rest of the neurons and is not repeated herein. During training of the backbone network, the performance of the backbone network is improved by adjusting weights in the backbone network.

For example, the weights in the backbone network may be updated using a gradient descent method, such as a stochastic gradient descent method (SGD). Specifically, all the weights in the backbone network are updated according to the gradient descent method. However, the applicants have found through research that the update method of updating all the weights may result in a high training cost and a low training efficiency for the electronic device.

On this basis, in the embodiment of the present application, the weight selection cycle is set. When the weight selection cycle elapses, some of the weights in the backbone network are selected, and only the selected weights need to be adjusted during subsequent training of the backbone network, while the unselected weights in the backbone network remain unchanged. In this way, the cost of training the backbone network can be reduced, and the efficiency of training the backbone network can be improved.

The weight selection cycle includes at least one backbone network training cycle, and the backbone network training cycle may be understood as a period of time used for each training of the backbone network. For example, the weight selection cycle may include 20 backbone network training cycles, which indicates that one weight selection cycle elapses after the backbone network is trained 20 times.

In one possible implementation, an embodiment of the present application provides a specific implementation for setting the weight selection cycle, which includes the following operations.

A1: Determine a total number of backbone network training cycles and a number of weight selections.

The total number of backbone network training cycles may be understood as a total number of times the backbone network is trained during an overall training process of the backbone network. The number of weight selections may be understood as a total number of times weights are selected during the overall training process of the backbone network.

For example, the total number of backbone network training cycles may be 100, i.e., after the backbone network is trained 100 times, the training of the backbone network is ended, and a trained backbone network is obtained. The number of weight selections may be 5, i.e., during 100 trainings of the backbone network, the number of times the weights in the backbone network are selected is 5, that is, one backbone network weight selection is made every 20 times the backbone network is trained.

A2: Determine the weight selection cycle based on the total number of backbone network training cycles and the number of weight selections.

For example, a quotient of the total number of backbone network training cycles and the number of weight selections is determined as the weight selection cycle. For example, the weight selection cycle may be 100/5=20 times the backbone network is trained.

It can be understood that the backbone network training cycle may be the same as the weight selection cycle, in which case one backbone network weight selection is made every time the backbone network is trained. It can be learned that the weight selection cycle is not limited in the embodiment of the present application, which may be set according to actual training needs of the backbone network.

S202: Train the backbone network with sample data in the current weight selection cycle, and record a cumulative weight adjustment amount for each weight in the backbone network in the current weight selection cycle. The sample data includes sample images in the field of computer vision.

The backbone network is trained in each backbone network training cycle until the total number of backbone network training cycles is reached, and the training of the backbone network is then ended. Specifically, the backbone network is trained with the sample data. The sample data is a large-scale dataset, and includes the sample images in the field of computer vision and sample features of the sample images. The sample images are input images to the backbone network. The backbone network is used to extract and output the image features of the sample images, where the sample features are desired outputs of the backbone network, which are label values.

The backbone network is trained with the sample data in the current weight selection cycle. That is, the backbone network is trained in each backbone network training cycle within the current weight selection cycle. In addition, a weight adjustment amount corresponding to each weight in the backbone network may be recorded every time the backbone network is trained for a backbone network training cycle. Further, statistics on the cumulative weight adjustment amount for each weight may be collected at the end of the training of the backbone network in the current weight selection cycle. The cumulative weight adjustment amount for each weight is obtained through accumulation of at least one weight adjustment amount. The at least one weight adjustment amount is obtained by training the backbone network for at least one backbone network training cycle, and the at least one backbone network training cycle is the backbone network training cycle in the current weight selection cycle. For example, the at least one backbone network training cycle is all backbone network training cycles in the current weight selection cycle.

As an optional example, if weights in the backbone network are adjusted using the gradient descent method, a weight adjustment amount corresponding to each weight may be obtained from the gradient descent method, for example, in the gradient descent method, w=w−η(∂L/∂w) where w is a weight, η is a learning rate, L is a loss function/objective function constructed for training the backbone network, ∂L/∂w is a gradient of the loss function with respect to the weight, and η(∂L/∂w) may be understood as a weight adjustment amount. It can be learned that the weight adjustment amount may also be calculated according to other calculation methods, which is not limited herein.

For example, w1 is a weight in the backbone network, and the current weight selection cycle includes 20 backbone network training cycles. In this case, every time the backbone network is trained for a backbone network training cycle, the weight adjustment amount for w1 may be calculated according to the gradient descent method. Further, 20 weight adjustment amounts obtained for w1 in the current weight selection cycle are accumulated to obtain a cumulative weight adjustment amount for w1 in the current weight selection cycle.

It can be understood that every time the backbone network is trained for a backbone network training cycle, the weight adjustment amount corresponding to each weight may be calculated, which does not mean that the weight is actually adjusted based on the weight adjustment amount. Instead, after one weight selection cycle, some of the weights are selected from all the weights in the backbone network based on the cumulative weight adjustment amount for each weight, and then adjusted during subsequent training of the backbone network.

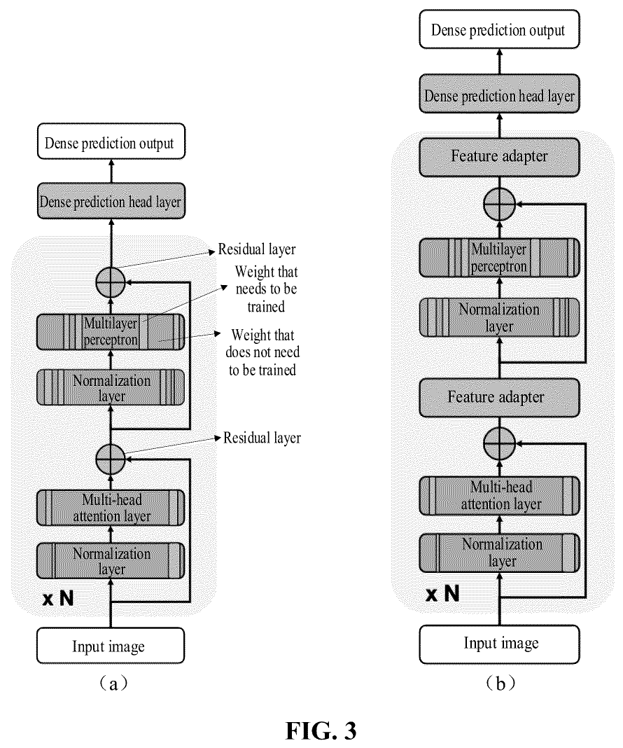

Referring to FIG. 3, FIG. 3(a) and FIG. 3(b) are respectively schematic diagrams of structures of two types of backbone networks according to an embodiment of the present application.

As an optional example, the backbone network is used to build a machine learning model in the field of computer vision. The machine learning model may be an image processing model, a semantic segmentation model, an object detection model, etc., which is not limited herein, and may be determined depending on specific application scenarios in the field of computer vision. As shown in FIG. 3(a), the machine learning model includes a head network and at least one backbone network. The head network may also be referred to as a dense prediction head layer (Dense Head), which is used to obtain prediction results of the model. Herein, the internal structure of the head network is not limited. There may be a number N of backbone networks, and the N backbone networks have the same structure.

As an optional example, as shown in FIG. 3(a), the backbone network includes a first structural block and a second structural block. The first structural block includes a normalization layer (Layer Norm) and a multi-head attention layer (MH-Attention), and the second structural block includes a normalization layer (Layer Norm) and a multilayer perceptron (MLP).

In addition, each of the first structural block and the second structural block of the backbone network may be followed by a residual layer. The residual layer functions to pass an output of the previous layer in the backbone network to a next layer.

Sample images are input into the backbone network as input images. The sample images first pass through the normalization layer and the multi-head attention layer of the first structural block, and are then input, by the residual layer, into the second structural block together with an output of the multi-head attention layer. In the second structural block, the output and the sample images are processed first in the normalization layer, and then by the multilayer perceptron.

As shown in FIG. 3(a), another residual layer in the backbone network inputs an output of the multilayer perceptron, the output of the multi-head attention layer, and the sample images together into the head network for model prediction by the head network, to obtain a predicted output. In the case of dense prediction tasks, the output is specifically a dense prediction output.

For example, the plurality of normalization layers, the multi-head attention layer, and the multilayer perceptron each may be a neural network. Therefore, the weights in the backbone network in the embodiments of the present application may mean weights in a plurality of neural network layers within the backbone network, for example, weights in the plurality of normalization layers, the multi-head attention layer, and the multilayer perceptron.

In addition, the head network is trained synchronously during the training of the backbone network. During specific implementation, weights in the head network are trained synchronously. For example, any weight in the head network may be trained synchronously without a weight selection process.

S203: Determine, as a target weight in the backbone network, a weight for which the cumulative weight adjustment amount meets a preset condition.

It can be learned that a greater weight adjustment amount results in a greater cumulative weight adjustment amount, which indicates a greater change in the weight. The training process of the backbone network includes a forward pass process and a backward gradient derivation process. The weight in the backbone network is adjusted according to an objective function constructed. A greater change in the weight indicates a greater importance of the weight in the training process of the backbone network.

Then, after the cumulative weight adjustment amount for each weight in the current weight selection cycle is obtained, it is determined whether the cumulative weight adjustment amount for each weight meets the preset condition. The weight that meets the preset condition is determined as the target weight in the backbone network. There is one or more target weights. That is, with the cumulative weight adjustment amount for each weight (which can reflect the importance of the weight in the training process of the backbone network) as a basis for selection, a weight is selected from the weights in the backbone network, to obtain the target weight. It can be considered that during the training of the backbone network, the adjustment to the target weight has a greater impact on the performance of the backbone network.

In one possible implementation, an embodiment of the present application provides a specific implementation for determining, as a target weight in a backbone network, a weight for which the cumulative weight adjustment amount meets a preset condition, which includes B1 and B2.

B1: Obtain a target number of weights with the greatest cumulative weight adjustment amount. The target number is a single-cycle weight adjustment number.

It can be learned that the target number of weights with the greatest cumulative weight adjustment amount have a greater impact on the performance of the backbone network. The target number may be denoted as K.

B2: Determine each of the target number of weights as the target weight in the backbone network.

For example, if the target number K is 1, a weight with the greatest cumulative weight adjustment amount is determined as the target weight.

In one possible implementation, an embodiment of the present application provides a specific implementation for determining the single-cycle weight adjustment number in B1, which includes C1 to C3.

C1: Determine a total number of weights in the backbone network and a weight adjustment proportion. The weight adjustment proportion is a proportion of a number of weights adjusted during an overall training process of the backbone network in the total number of weights.

The total number of weights in the backbone network is related to an internal structure of the backbone network. For example, the total number of weights is related to the plurality of normalization layers, the multi-head attention layer, and the multilayer perceptron in the backbone network. After the internal structure of the backbone network is determined, the total number of all weights in the backbone network may be determined.

The number of weights to be adjusted during the overall training process of the backbone network may be set according to actual situations, which is not limited herein.

For example, if the number of weights adjusted during the overall training process of the backbone network is 5 and the total number of weights is 100, the weight adjustment proportion is 5%. This is described here by way of example only.

C2: Determine a single-cycle weight adjustment proportion in the weight selection cycle based on the number of weight selections and the weight adjustment proportion.

For example, a quotient of the weight adjustment proportion and the number of weight selections is determined as the single-cycle weight adjustment proportion in the weight selection cycle. The single-cycle weight adjustment proportion represents a proportion of the number of weights selected per time in the total number of weights.

For example, if the number of weight selections is 5, the single-cycle weight adjustment proportion is 5%/5=1%.

C3: Determine the single-cycle weight adjustment number in the weight selection cycle based on the single-cycle weight adjustment proportion and the total number of weights.

For example, a product of the single-cycle weight adjustment proportion and the total number of weights is determined as the single-cycle weight adjustment number K in the weight selection cycle. For example, the single-cycle weight adjustment number K is 1%×100=1.

It can be learned from C1 to C3 that, if the number of times the weights in the backbone network are selected is 5 during 100 trainings of the backbone network, one backbone network weight selection is made every 20 times the backbone network is trained, and one target weight is selected from all weights in the backbone network during each selection of the weights in the backbone network. The target weight may be a weight with the greatest cumulative weight adjustment amount in the backbone network.

S204: Adjust the target weight in the backbone network, to complete training of the backbone network in a next weight selection cycle based on the adjusted target weight.

After the current weight selection cycle, the target weight is selected and determined as a trainable weight in the backbone network, and other weights are determined as untrainable weights in the backbone network. Further, in the next weight selection cycle, only the target weight in the backbone network is adjusted, to complete the training of the backbone network in the next weight selection cycle based on the adjusted target weight. For example, the target weight may be adjusted based on an adjustment amount for the target weight. An adjustment amount for a weight may be obtained according to the gradient descent method.

When the backbone network is trained in the next weight selection cycle, which is a new current weight selection cycle, a new target weight may be selected based on a cumulative weight adjustment amount for each weight in the next weight selection cycle. Then, during subsequent training of the backbone network, previously determined target weights in backbone network may be adjusted.

It can be understood that the adjusted target weights in the backbone network are target weights determined after all previous weight selection cycles.

For example, if the current weight selection cycle is an initial weight selection cycle, a target weight of w1 is determined after the current weight selection cycle. After the next weight selection cycle, the target weight w1 in the backbone network may be trained. A target weight of w2 is determined after the next weight selection cycle, and then the target weights, i.e., w1 and w2, in the backbone network may then be trained in a weight selection cycle after the next weight selection cycle.

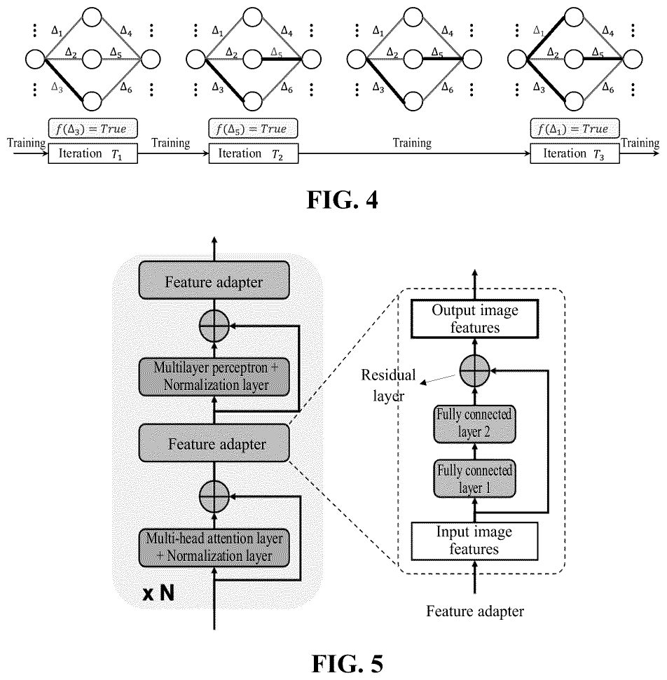

Referring to FIG. 4, FIG. 4 is a schematic diagram of backbone network weight selection and backbone network training according to an embodiment of the present application. As shown in FIG. 4, T1 may be 20 backbone network training cycles, T2 may be 40 backbone network training cycles, and T3 may be 60 backbone network training cycles, that is, one target weight is selected once from the weights in the backbone network every 20 backbone network training cycles.

An initial weight adjustment cycle is a weight adjustment cycle T1. In the weight adjustment cycle T1, a backbone network is trained. When T1 elapses, it is determined that a cumulative weight adjustment amount Δ₃ is the greatest, and its corresponding weight w3 is then determined as a target weight.

In a weight adjustment cycle T2, the backbone network is trained such that the target weight w3 is adjusted. When T2 elapses, it is determined that a cumulative weight adjustment amount Δ₅ is the greatest for all weights in T2, and its corresponding weight w5 is then determined as a target weight.

In a weight adjustment cycle T3, the backbone network is trained such that the target weights w3 and w5 are adjusted. When T3 elapses, it is determined that a cumulative weight adjustment amount Δ₁ is the greatest for all weights in T3, and its corresponding weight w1 is then determined as a target weight. In the next weight adjustment cycle, the backbone network is trained such that the target weights w3, w5 and w1 may be adjusted. This is analogous for subsequent weight adjustment cycles and are not repeated herein.

In addition, instead of training and storing a set of weight parameters of the backbone network for each dense prediction task, weights of a target backbone network are shared among different dense prediction tasks after the target backbone network is obtained according to the method for training a backbone network provided in the embodiment of the present application, so that a high network performance cannot only be maintained, but the model storage overhead can also be significantly reduced.

It can be learned from the relevant content in S201 to S204 that in the method for training a backbone network provided in the embodiment of the present application, untrainable weights of higher importance are selected from the backbone network step by step, and the selected untrainable weights are converted into trainable weights and then engaged in subsequent training of the backbone network. In this way, the backbone network contains the trainable weights and the untrainable weights, and only a small number of weights in the backbone network need to be adjusted, while other weights remain unchanged, so that the number of resources used by the electronic device in training the backbone network can be reduced, and the efficiency of training the backbone network on the electronic device can be improved.

As an optional example, the backbone network may further include a feature adapter, which is configured to adjust an output of the previous network.

For example, the backbone network shown in FIG. 3(b) includes two feature adapters. As shown in FIG. 3(b), a first structural block of the backbone network may be connected to a second structural block thereof through one feature adapter. This feature adapter is configured to adjust an output of the first structural block. Specifically, the feature adapter is connected after a residual layer (the residual layer between the first structural block and the second structural block), for adjusting an output of the residual layer, i.e., an output feature of the first structural block, and an input image.

As shown in FIG. 3(b), the second structural block may be connected to a head network through the other feature adapter configured to adjust an output of the second structural block. Specifically, the feature adapter is connected after another residual layer (the residual layer between the second structural block and the head network), for adjusting an output of the other residual layer, i.e., an output of a multilayer perceptron, an output of a multi-head attention layer, and a sample image.

The feature adapter is trainable, and it is trained synchronously during training of the backbone network. Specifically, any weight in the feature adapter is trained synchronously without a weight selection process.

With the feature adapter between the first structural block and the second structural block as an example, it should be understood that after a weight selection cycle, if any of the weights in the first structural block is not a target weight, and is an untrainable weight, a feature adapter that can adjust weights is connected between the first structural block and the second structural block, to make the feature representation of the backbone network more accurate by means of the weight adjustment in the feature adapter. In this way, in addition to adjusting only the trainable target weights to improve the efficiency of training the backbone network, the addition of the feature adapter may further make the feature representation of the backbone network more accurate, to maintain a high performance for dense prediction tasks.

In addition, two feature adapters are provided after each structural block in the backbone network, so that the performance may be improved without increasing the number of parameters to be trained too much.

Referring to FIG. 5, FIG. 5 is a schematic diagram of a structure of a feature adapter according to an embodiment of the present application. As shown in FIG. 5, the feature adapter may include a first fully connected layer (for example, a fully connected layer 1 of FIG. 5), a second fully connected layer (for example, a fully connected layer 2 of FIG. 5), and a residual layer that are connected to each other. The first fully connected layer is used to implement feature extraction and feature dimensionality reduction, i.e., down-sampling, and the second fully connected layer is used to implement feature recovery and feature dimensionality augmentation, i.e., up-sampling. In this structure, the fully connected layers are used to implement remapping of features, and the features are adjusted through weight adjustments in the fully connected layers, to make the feature representation more accurate.

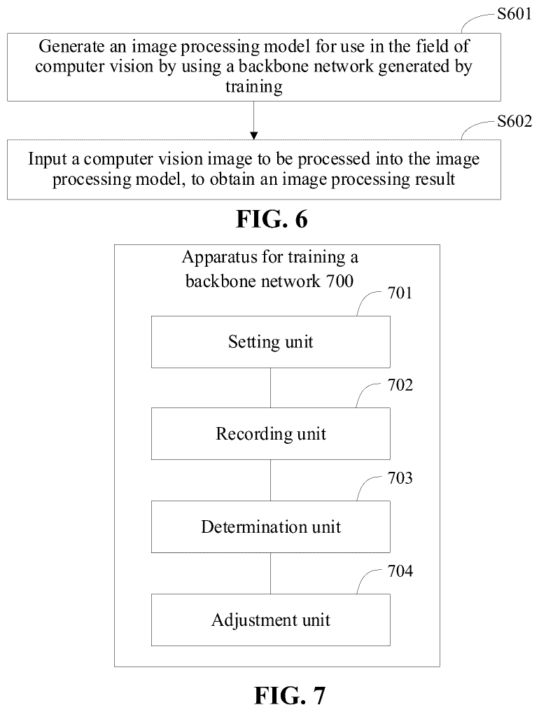

Referring to FIG. 6, FIG. 6 is a flowchart of an image processing method according to an embodiment of the present application. As shown in FIG. 6, the embodiment of the present application provides an image processing method. The method includes S601 and S602.

S601: Generate an image processing model for use in the field of computer vision by using a backbone network generated by training through the method for training a backbone network according to any one of the above embodiments.

The image processing model is a machine learning model.

S602: Input a computer vision image to be processed into the image processing model, to obtain an image processing result.

It can be understood that the computer vision image to be processed varies depending on application scenarios in the field of computer vision, which is not limited herein.

Those skilled in the art can understand that, in the above methods of the specific implementations, the order in which the steps are written does not imply a strict execution order, and does not constitute any limitation on the implementation process. The specific execution order of the steps should be determined by their functions and possible internal logics.

Based on the method for training a backbone network according to the above method embodiment, an embodiment of the present application further provides an apparatus for training a backbone network. The apparatus for training a backbone network is described below with reference to the accompanying drawing. Because the principle of solving the problem by the apparatus in the embodiment of the present application is similar to that of the method for training a backbone network described above in the embodiment of the present application, for the implementation of the apparatus, reference may be made to the implementation of the method, which is not repeated herein.

Referring to FIG. 7, it is a schematic diagram of a structure of an apparatus for training a backbone network according to an embodiment of the present application. The apparatus may be applied to an electronic device in which a backbone network is deployed. In the backbone network, adjacent neural network layers are associated with each other and have associated weights. As shown in FIG. 7, the apparatus for training a backbone network includes:
a setting unit 701 configured to set a weight selection cycle, where the weight selection cycle includes at least one backbone network training cycle;
a recording unit 702 configured to train the backbone network with sample data in the current weight selection cycle, and record a cumulative weight adjustment amount for each weight in the backbone network in the current weight selection cycle, where the sample data includes sample images in the field of computer vision;
a determination unit 703 configured to determine, as a target weight in the backbone network, a weight for which the cumulative weight adjustment amount meets a preset condition; and
an adjustment unit 704 configured to adjust the target weight in the backbone network, to complete training of the backbone network in a next weight selection cycle based on the adjusted target weight.

In one possible implementation, the cumulative weight adjustment amount is obtained through accumulation of at least one weight adjustment amount; and the at least one weight adjustment amount is obtained by training the backbone network for at least one backbone network training cycle.

In one possible implementation, the determination unit 703 includes:
an obtaining sub-unit configured to obtain a target number of weights with the greatest cumulative weight adjustment amount, where the target number is a single-cycle weight adjustment number; and
a first determination sub-unit configured to determine each of the target number of weights as the target weight in the backbone network.

In one possible implementation, the backbone network includes a first structural block and a second structural block, and the first structural block is connected to the second structural block through a feature adapter; the feature adapter is configured to adjust an output of the first structural block; the feature adapter is trained synchronously during the training of the backbone network; and
the first structural block includes a normalization layer and a multi-head attention layer, and the second structural block includes a normalization layer and a multilayer perceptron.

In one possible implementation, the backbone network is used to build a machine learning model in the field of computer vision; the machine learning model includes a head network and at least one backbone network; the head network is trained synchronously during the training of the backbone network; and
the second structural block is connected to the head network through a feature adapter configured to adjust an output of the second structural block.

In one possible implementation, the feature adapter includes a first fully connected layer, a second fully connected layer, and a residual layer that are connected to each other; and the first fully connected layer is used to implement feature dimensionality reduction, and the second fully connected layer is used to implement feature dimensionality augmentation.

In one possible implementation, the setting unit 701 includes:
a second determination sub-unit configured to determine a total number of backbone network training cycles and a number of weight selections; and
a third determination sub-unit configured to determine the weight selection cycle based on the total number of backbone network training cycles and the number of weight selections.

A process of obtaining the single-cycle weight adjustment number includes:
determining a total number of weights in the backbone network and a weight adjustment proportion, where the weight adjustment proportion is a proportion of a number of weights adjusted during an overall training process of the backbone network in the total number of weights;
determining a single-cycle weight adjustment proportion in the weight selection cycle based on the number of weight selections and the weight adjustment proportion; and
determining the single-cycle weight adjustment number in the weight selection cycle based on the single-cycle weight adjustment proportion and the total number of weights.

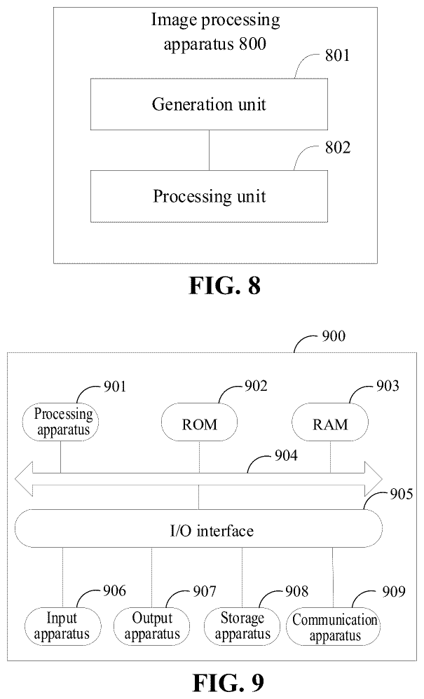

Referring to FIG. 8, FIG. 8 is a schematic diagram of a structure of an image processing apparatus according to an embodiment of the present application. As shown in FIG. 8, the image processing apparatus includes:
a generation unit 801 configured to generate an image processing model for use in the field of computer vision by using a backbone network generated by training through the method for training a backbone network according to any one of the above embodiments;
a processing unit 802 configured to input a computer vision image to be processed into the image processing model, to obtain an image processing result.

The implementations provided by the present application in the above aspects may also be further combined to provide more implementations.

It should be noted that for the specific implementation of each unit in the embodiment, reference may be made to the related description in the above method embodiment. The division of the units in the embodiment of the present application is schematic, which is merely logical function division, and there may be other division methods during actual implementation. Various functional units in the embodiments of the present application may be integrated into one processing unit, each of the units may exist alone physically, or two or more units may be integrated into one unit. For example, in the above embodiment, the processing unit and the sending unit may be the same unit, or may be different units. The above integrated unit may be implemented in the form of hardware, or may be implemented in the form of a software functional unit.

Based on the method for training a backbone network according to the above method embodiment, the present application further provides an electronic device. The electronic device includes: one or more processors; and a storage apparatus having one or more programs stored thereon, where the one or more programs, when executed by the one or more processors, cause the one or more processors to implement the method for training a backbone network according to any one of the above embodiments.

Reference is made to FIG. 9 below, which is a schematic diagram of a structure of an electronic device 900 suitable for implementing an embodiment of the present application. The terminal device in this embodiment of the present application may include, but is not limited to, a mobile terminal such as a mobile phone, a notebook computer, a digital broadcast receiver, a personal digital assistant (PDA), a tablet computer (Portable Android Device, PAD), a portable media player (PMP), and a vehicle-mounted terminal (such as a vehicle navigation terminal), and a fixed terminal such as a digital television (TV) and a desktop computer. The electronic device shown in FIG. 9 is merely an example and should not impose any limitation on the functionality and scope of use of the embodiments of the present application.

As shown in FIG. 9, the electronic device 900 may include a processing apparatus (e.g., a central processing unit, a graphics processing unit, etc.) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for operations of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the shown apparatuses. It may be an alternative to implement or have more or fewer apparatuses.

In particular, according to an embodiment of the present application, the process described above with reference to the flowcharts may be implemented as a computer software program. For example, this embodiment of the present application includes a computer program product, which includes a computer program carried on a non-transitory computer-readable medium, where the computer program includes program code for performing the method shown in the flowchart. In such an embodiment, the computer program may be downloaded and installed from a network through the communication apparatus 909, installed from the storage apparatus 908, or installed from the ROM 902. When the computer program is executed by the processing apparatus 901, the above-mentioned functions defined in the method of the embodiment of the present application are performed.

The electronic device according to this embodiment of the present application and the method for training a backbone network according to the above embodiment belong to the same inventive concept. For the technical details not described in detail in this embodiment, reference can be made to the above embodiment, and this embodiment and the above embodiment have the same beneficial effects.

Based on the method for training a backbone network according to the above method embodiment, an embodiment of the present application provides a computer-readable medium having a computer program stored thereon, where when the program is executed by a processor, the method for training a backbone network according to any one of the above embodiments is implemented.

It should be noted that the above computer-readable medium described in the present application may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present application, the computer-readable storage medium may be any tangible medium containing or storing a program which may be used by or in combination with an instruction execution system, apparatus, or device. In the present application, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hyper Text Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the above method for training a backbone network.

The computer program code for performing the operations in the present application may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present application. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present application may be implemented by software, or may be implemented by hardware. Names of the units/modules do not constitute a limitation on the units themselves in some cases, for example, a voice data acquisition module may alternatively be described as “a data acquisition module”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present application, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

It should be noted that the embodiments in this specification are described in a progressive manner. Each embodiment focuses on differences from other embodiments. For a part that is the same or similar between different embodiments, reference may be made between the embodiments. The system or apparatus disclosed in the embodiments corresponds to the method disclosed in the embodiments, and is thus described briefly. For related parts, reference may be made to the part of the description of the method.

It should be understood that in the present application, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A and B may be singular or plural. The character “/” generally indicates an “or” relationship between the associated objects. “At least one of” or any similar expression thereof refers to any combination of all items, including a single item or any combination of a plurality of items. For example, at least one of a, b, or c may indicate: a, b, c, “a and b”, “a and c”, “b and c”, or “a, b, and c”, where a, b, and c may be singular or plural.

It should also be noted that the relational terms such as first and second herein are only used to distinguish one entity or operation from another, and do not necessarily require or imply that any actual relationship or sequence exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the methods or algorithms described with reference to the embodiments disclosed herein may be directly implemented in hardware, in a software module executed by a processor, or in a combination of both. The software module may be placed in a random access memory (RAM), an internal memory, a read-only memory (ROM), an electrically programmable ROM, an electrically erasable programmable ROM, a register, a hard disk, a removable disk, a CD-ROM, or any other form of storage medium well known in the art.

Through the foregoing description of the disclosed embodiments, those skilled in the art can implement or use the present application. Various modifications to these embodiments are apparent to those skilled in the art, and the general principle defined herein may be practiced in other embodiments without departing from the spirit or scope of the present application. Therefore, the present application will not be limited to the embodiments shown herein, but extends to the widest scope that complies with the principles and novelty disclosed in this specification.

I/We claim:

1. A method for training a backbone network, wherein in the backbone network, adjacent neural network layers are associated with each other and have associated weights, the method comprising:
setting a weight selection cycle, wherein the weight selection cycle comprises at least one backbone network training cycle;
training the backbone network with sample data in the current weight selection cycle, and recording a cumulative weight adjustment amount for each weight in the backbone network in the current weight selection cycle, wherein the sample data comprises sample images in the field of computer vision;
determining, as a target weight in the backbone network, a weight for which the cumulative weight adjustment amount meets a preset condition; and
adjusting the target weight in the backbone network, to complete training of the backbone network in a next weight selection cycle based on the adjusted target weight.

2. The method according to claim 1, wherein the cumulative weight adjustment amount is obtained through accumulation of at least one weight adjustment amount; and the at least one weight adjustment amount is obtained by training the backbone network for at least one backbone network training cycle.

3. The method according to claim 1, wherein the determining, as a target weight in the backbone network, a weight for which the cumulative weight adjustment amount meets a preset condition comprises:
obtaining a target number of weights with the greatest cumulative weight adjustment amount, wherein the target number is a single-cycle weight adjustment number; and
determining each of the target number of weights as the target weight in the backbone network.

4. The method according to claim 1, wherein the backbone network comprises a first structural block and a second structural block, and the first structural block is connected to the second structural block through a feature adapter; the feature adapter is configured to adjust an output of the first structural block; the feature adapter is trained synchronously during the training of the backbone network; and
the first structural block comprises a normalization layer and a multi-head attention layer, and the second structural block comprises a normalization layer and a multilayer perceptron.

5. The method according to claim 4, wherein the backbone network is used to build a machine learning model in the field of computer vision; the machine learning model comprises a head network and at least one backbone network; the head network is trained synchronously during the training of the backbone network; and
the second structural block is connected to the head network through a feature adapter configured to adjust an output of the second structural block.

6. The method according to claim 4, wherein the feature adapter comprises a first fully connected layer, a second fully connected layer, and a residual layer that are connected to each other; and the first fully connected layer is used to implement feature dimensionality reduction, and the second fully connected layer is used to implement feature dimensionality augmentation.

7. The method according to claim 3, wherein the setting a weight selection cycle comprises:
determining a total number of backbone network training cycles and a number of weight selections; and
determining the weight selection cycle based on the total number of backbone network training cycles and the number of weight selections; and
a process of obtaining the single-cycle weight adjustment number comprises:
determining a total number of weights in the backbone network and a weight adjustment proportion, wherein the weight adjustment proportion is a proportion of a number of weights adjusted during an overall training process of the backbone network in the total number of weights;
determining a single-cycle weight adjustment proportion in the weight selection cycle based on the number of weight selections and the weight adjustment proportion; and
determining the single-cycle weight adjustment number in the weight selection cycle based on the single-cycle weight adjustment proportion and the total number of weights.

8. An image processing method, comprising:
generating an image processing model for use in the field of computer vision by using a backbone network generated by a process for training the backbone network, wherein in the backbone network, adjacent neural network layers are associated with each other and have associated weights, the process comprising:
setting a weight selection cycle, wherein the weight selection cycle comprises at least one backbone network training cycle;
training the backbone network with sample data in the current weight selection cycle, and recording a cumulative weight adjustment amount for each weight in the backbone network in the current weight selection cycle, wherein the sample data comprises sample images in the field of computer vision;
determining, as a target weight in the backbone network, a weight for which the cumulative weight adjustment amount meets a preset condition; and
adjusting the target weight in the backbone network, to complete training of the backbone network in a next weight selection cycle based on the adjusted target weight; and
inputting a computer vision image to be processed into the image processing model, to obtain an image processing result.

9. The method according to claim 8, wherein the cumulative weight adjustment amount is obtained through accumulation of at least one weight adjustment amount; and the at least one weight adjustment amount is obtained by training the backbone network for at least one backbone network training cycle.

10. The method according to claim 8, wherein the determining, as a target weight in the backbone network, a weight for which the cumulative weight adjustment amount meets a preset condition comprises:
obtaining a target number of weights with the greatest cumulative weight adjustment amount, wherein the target number is a single-cycle weight adjustment number; and
determining each of the target number of weights as the target weight in the backbone network.

11. The method according to claim 8, wherein the backbone network comprises a first structural block and a second structural block, and the first structural block is connected to the second structural block through a feature adapter; the feature adapter is configured to adjust an output of the first structural block; the feature adapter is trained synchronously during the training of the backbone network; and
the first structural block comprises a normalization layer and a multi-head attention layer, and the second structural block comprises a normalization layer and a multilayer perceptron.

12. The method according to claim 11, wherein the backbone network is used to build a machine learning model in the field of computer vision; the machine learning model comprises a head network and at least one backbone network; the head network is trained synchronously during the training of the backbone network; and
the second structural block is connected to the head network through a feature adapter configured to adjust an output of the second structural block.

13. The method according to claim 11, wherein the feature adapter comprises a first fully connected layer, a second fully connected layer, and a residual layer that are connected to each other; and the first fully connected layer is used to implement feature dimensionality reduction, and the second fully connected layer is used to implement feature dimensionality augmentation.

14. The method according to claim 10, wherein the setting a weight selection cycle comprises:
determining a total number of backbone network training cycles and a number of weight selections; and
determining the weight selection cycle based on the total number of backbone network training cycles and the number of weight selections; and
a process of obtaining the single-cycle weight adjustment number comprises:
determining a total number of weights in the backbone network and a weight adjustment proportion, wherein the weight adjustment proportion is a proportion of a number of weights adjusted during an overall training process of the backbone network in the total number of weights;
determining a single-cycle weight adjustment proportion in the weight selection cycle based on the number of weight selections and the weight adjustment proportion; and
determining the single-cycle weight adjustment number in the weight selection cycle based on the single-cycle weight adjustment proportion and the total number of weights.

15. An electronic device, comprising:
one or more processors; and
a storage apparatus having one or more programs stored thereon, wherein
the one or more programs, when executed by the one or more processors, cause the one or more processors to train a backbone network, wherein in the backbone network, adjacent neural network layers are associated with each other and have associated weights, and the one or more programs cause the one or more processors to:
set a weight selection cycle, wherein the weight selection cycle comprises at least one backbone network training cycle;
train the backbone network with sample data in the current weight selection cycle, and record a cumulative weight adjustment amount for each weight in the backbone network in the current weight selection cycle, wherein the sample data comprises sample images in the field of computer vision;
determine, as a target weight in the backbone network, a weight for which the cumulative weight adjustment amount meets a preset condition; and
adjust the target weight in the backbone network, to complete training of the backbone network in a next weight selection cycle based on the adjusted target weight.

16. The electronic device according to claim 15, wherein the cumulative weight adjustment amount is obtained through accumulation of at least one weight adjustment amount; and the at least one weight adjustment amount is obtained by training the backbone network for at least one backbone network training cycle.

17. The electronic device according to claim 15, wherein the one or more programs causing the one or more processors to determine, as a target weight in the backbone network, a weight for which the cumulative weight adjustment amount meets a preset condition further cause the one or more processors to:
obtain a target number of weights with the greatest cumulative weight adjustment amount, wherein the target number is a single-cycle weight adjustment number; and
determine each of the target number of weights as the target weight in the backbone network.

18. The electronic device according to claim 15, wherein the backbone network comprises a first structural block and a second structural block, and the first structural block is connected to the second structural block through a feature adapter; the feature adapter is configured to adjust an output of the first structural block; the feature adapter is trained synchronously during the training of the backbone network; and
the first structural block comprises a normalization layer and a multi-head attention layer, and the second structural block comprises a normalization layer and a multilayer perceptron.

19. The electronic device according to claim 18, wherein the backbone network is used to build a machine learning model in the field of computer vision; the machine learning model comprises a head network and at least one backbone network; the head network is trained synchronously during the training of the backbone network; and
the second structural block is connected to the head network through a feature adapter configured to adjust an output of the second structural block.

20. The electronic device according to claim 18, wherein the feature adapter comprises a first fully connected layer, a second fully connected layer, and a residual layer that are connected to each other; and the first fully connected layer is used to implement feature dimensionality reduction, and the second fully connected layer is used to implement feature dimensionality augmentation.
